(19) United States
(12) Patent Application Publication
(10) Pub. No.: US 2026/0238134 A1
(43) Pub. Date: Aug. 13, 2026

(54) Soft Switching Two Transistor Forward With Dual Clamp For High Voltage Bus And Large Input Voltage Range

(71) Applicant: Rompower Technology Holdings, LLC, Milford, DE (US)

(72) Inventors: Ionel Jitaru, Tucson, AZ (US); Mihai Bogdan Jitariu, Neamt (RO); Andrei Stefan Savu, Bucuresti (RO)

(73) Assignee: Rompower Technology Holdings, LLC, Milford, DE (US)

(21) Appl. No.: 19/537,766

(22) Filed: Feb. 12, 2026

Related U.S. Application Data
(60) Provisional application No. 63/757,740, filed on Feb. 12, 2025.

(51) Int. Cl. H02M 3/335

(52) U.S. Cl. CPC H02M 3/33576; H02M 3/33569; H02M 3/33592

(57) ABSTRACT

Disclosed is an embodiment of electronic circuitry and a method of operating electronic circuitry to obtain zero voltage switching on both primary switches in a dual clamp two transistors forward topology, in all operating conditions. Zero voltage switching is accomplished through the magnetizing current energy and through a combination of the magnetizing current energy and current injection.

### CROSS-REFERENCE TO RELATED APPLICATIONS

This application claims the benefit of U.S. Provisional Application No. 63/757,740, filed Feb. 12, 2025, which is hereby incorporated by reference in its entirety.

### FIELD

The present specification relates generally to electronic devices, and more particularly to power converters.

### BACKGROUND

Since at least the early 1990s, efforts have been undertaken to develop techniques for converting hard-switching power-conversion topologies into soft-switching topologies. Such efforts have been primarily directed toward forward-derived converter topologies, which are widely used in medium- and high-power power-conversion applications.

Isolated power converter topologies generally include a primary side and a secondary side, wherein a primary circuit is ohmically connected to a primary winding of a transformer and a secondary circuit is ohmically connected to a secondary winding of the transformer. The primary winding and the secondary winding are magnetically coupled but are not ohmically connected, thereby providing galvanic isolation between the primary side and the secondary side. Representative examples of isolated, forward-derived converter topologies include, but are not limited to, half-bridge converters, full-bridge converters, and single-ended forward converters.

Such isolated converter topologies are widely employed in applications requiring safety isolation, high reliability, and wide input-voltage operating ranges, including industrial power supplies, telecommunications equipment, automotive electronics, and AC-DC conversion systems.

In medium-power applications, the single-ended forward topology has been widely adopted due to its relatively simple circuit structure, reduced component count, and favorable power-processing characteristics. Common implementations of the single-ended forward topology include, without limitation, the two-transistor forward converter and the single-ended active-clamp forward converter.

There is a continuing need for improved forward-derived isolated converter topologies that reduce switching losses, mitigate the effects of leakage inductance, and enable soft-switching operation while maintaining simplicity, low cost, and high efficiency in medium-power and high power applications. The single-ended active-clamp forward topology gained acceptance due to its ability to achieve soft-switching operation under certain operating conditions. In such topologies, zero-voltage switching (ZVS) of the primary switching device may be achieved by controlling the amplitude of the transformer magnetizing current in combination with a predetermined amount of transformer leakage inductance. Under appropriate operating conditions, the energy stored in the magnetizing inductance and leakage inductance is utilized to resonantly discharge the parasitic capacitance of the primary switching device prior to turn-on.

Conventional wire-wound transformers commonly employed in such forward-derived topologies typically exhibit a coupling coefficient in the range of approximately k=0.992 to 0.996.

$${L}_{lk} = {L}_{p} ( 1 - {K}^{2} ) \qquad ( 1 )$$

where Llk is the leakage inductance in the transformer;
Lp is the inductance of the primary winding; and
K is the coupling coefficient between primary and secondary winding.

Using Equation (1), it is determined that the leakage inductance reflected to the primary winding is in the range of approximately 2 μH to 5 μH for a transformer having a primary magnetizing inductance of approximately 300 μH. In addition to the inherent transformer leakage inductance, parasitic inductances associated with interconnections, device packages, and printed circuit board layouts contribute to the total effective leakage inductance of the converter.

Over the last several decades, the introduction of planar magnetic structures and the extensive adoption of surface-mount device (SMD) technology have resulted in a substantial reduction of both transformer leakage inductance and stray inductance in many power-conversion applications. For leakage inductance values in the range of approximately 2 μH to 5 μH, zero-voltage switching (ZVS) of the primary switching devices may be achieved by operating with relatively large magnetizing current amplitudes, particularly under full-load operating conditions.

However, in magnetic structures exhibiting very high coupling coefficients, such as coupling coefficients greater than approximately k>0.998, corresponding to leakage inductance values below approximately 1 μH, soft-switching operation cannot be reliably achieved using conventional approaches based solely on increased magnetizing current. In such conditions, the available inductive energy is insufficient to fully discharge the parasitic capacitances of the primary switching devices prior to turn-on, resulting in hard-switching operation.

### SUMMARY

This specification discloses systems, methods, and circuit embodiments that enable soft-switching operation even in power-conversion applications wherein the transformer leakage inductance is very small. Unlike solutions in which soft switching is achieved primarily across the primary switching devices and is strongly dependent on leakage inductance and magnetizing current magnitude, the embodiments disclosed herein implement a “true” soft-switching approach.

In accordance with the disclosed embodiments, “true” soft switching is achieved by ensuring zero-voltage switching (ZVS) of switching devices located on the primary side of the power converter and zero-current switching (ZCS) of switching elements located on the secondary side of the power converter. This coordinated ZVS/ZCS operation is accomplished independently of transformer leakage inductance magnitude and remains effective even when the coupling coefficient of the transformer approaches unity.

As a result, this specification enables high-efficiency “true” soft-switching operation across a wide range of magnetic implementations, including highly coupled planar transformers and other low-leakage magnetic structures, while reducing switching losses, electromagnetic interference, and stress on both primary and secondary switching devices.

The introduction of planar magnetic structures has created additional challenges related to common-mode noise, primarily due to increased parasitic capacitance between transformer windings, which leads to increased displacement currents in between primary and secondary windings. The present specification discloses several embodiments directed to reducing, and in some cases substantially eliminating, common-mode noise caused by such increased parasitic capacitances within the transformer.

These embodiments eliminate the need for special electrostatic shielding within the transformer and/or additional common-mode filtering at the input or output of the power converter. As a result, the size, cost, and complexity of power converters incorporating the embodiments of this specification are significantly reduced, while maintaining high efficiency and electromagnetic compatibility performance.

The above provides the reader with a brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 depicts a forward topology with active clamp.

FIG. 2 illustrates waveforms of operation for a forward topology with active clamp presented in FIG. 1.

FIG. 3 depicts a conventional two transistors forward topology.

FIG. 4 illustrates waveforms of a conventional two transistors forward topology

FIG. 5 depicts the voltage across the primary switching elements and the magnetizing current in the transformer in a two transistors forward topology.

FIG. 6 depicts waveforms in a two-transistor forward topology at lighter load.

FIG. 7. presents a dual clamp two transistor forward topology with dual secondary set of switching elements.

FIG. 8 depicts waveforms of the forward topology with active clamp from FIG. 1, at lighter load condition.

FIG. 9a. presents a two transistor topology with dual active clamp and with a current injection module in the secondary.

FIG. 9b presents the configuration of the current injection module.

FIG. 9c presents an implementation of a variable equivalent capacitor controlled by a switch.

FIG. 9d presents the configuration of the dual clamp, two transistor forward topology of FIG. 13, wherein a current injection winding and current injection circuit is implemented.

FIG. 10 depicts waveforms of the two transistor topology with dual active clamp and with a current injection module presented in FIG. 9a

FIG. 11 presents a two-transistor forward topology with active clamp and with a shorting switch circuit.

FIG. 12 depicts a two transistor forward topology with dual active clamp.

FIG. 13 depicts a two transistor forward topology with dual active clamp and very low common mode noise network, based on one of the embodiments of this specification.

FIG. 14 depicts a two transistor forward topology with dual active clamp and very low common mode noise network, based on one of the embodiments of this specification using two independent transformers.

FIG. 15 presents another embodiment of this specification formed by a two transistor forward topology with dual clamp and with shorting switch circuit across the primary winding.

FIG. 16 presents the power train configuration in the event wherein the energy is transfer from secondary to primary.

FIG. 17 is presented the time diagram wherein the energy is transferred from secondary to primary in the first mode of operation.

FIG. 18 depicts the time diagram wherein the energy is transferred from secondary to primary in the second mode of mode of operation.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

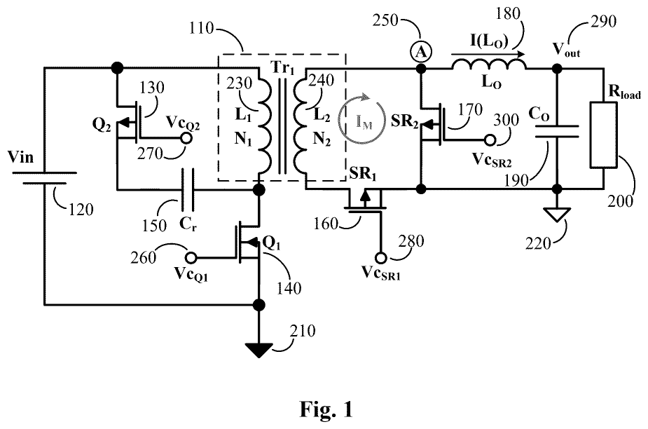

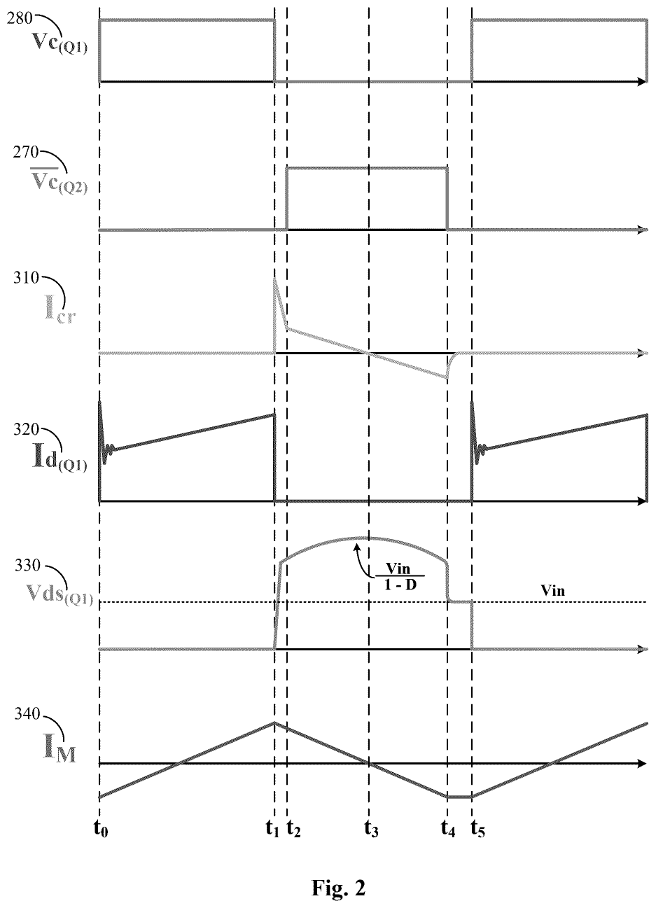

In FIG. 1 is depicted a single ended forward topology using active clamp. FIG. 2 presents waveforms including: control signals for the switch Q1 and Q2, the current through the clamp capacitor, Cr, the current through the main power switch Q1, the voltage across the main power switch Vds(Q1), and the magnetizing current IM. The magnetizing current is calculated based on formula (2). There are five time intervals.

$$IM = N 1 * I ( L 1 ) + N 2 * I ( L 2 ) \qquad ( 2 )$$

where IM is the magnetizing current;
N1 is the number of turns in the primary winding;
I(L1) is the current through the primary winding;
N2 is the number of turns in the secondary winding; and
I(L2) is the current through the secondary winding.

Between t₀ and t₁, a main power switch Q1 is in a conductive state, allowing current to flow through the primary winding of transformer Tr1, as represented by Id (Q1). During this interval, the magnetizing current I_{M} increases in magnitude as magnetic energy is stored in the core of the transformer.

At t₁, the main power switch Q1 is turned OFF. Due to the presence of leakage inductance Llk between the primary and secondary windings of the transformer, the current associated with Llk cannot change instantaneously and therefore continues to flow during the time interval from t₁ to t₂.

Between t₂ and t₃, the magnetizing current IM is redirected through a clamp capacitor Cr, decreasing until it reaches zero at t₃. Subsequently, during the interval from t₃ to t₄, the magnetizing current reverses polarity and increases in magnitude in the negative direction. At t₄, the current flowing through the clamp capacitor Cr reaches an amplitude substantially equal to the magnetizing current present at t₁, but with opposite polarity.

At t₄, a clamp switch Q2 is turned OFF. Following this event, the magnetizing current commutates through the parasitic capacitance of the main power switch Q1, flowing from the source terminal toward the drain terminal. As a result, the voltage across Q1 begins to discharge from an initial level of approximately Vin/(1-D) toward zero but the voltage does not go much lower than Vin, in applications wherein the leakage inductance in the transformer Tr1 has a low value. During this interval, a synchronous rectifier SR2 is conducting current through an output inductor Lo to supply the load.

In applications wherein the leakage inductance Llk is negligible, corresponding to a coupling coefficient K greater than approximately 0.998, the secondary circuit formed by SR2 and the body diode of SR1 effectively constitutes a short circuit. Under these conditions, the magnetizing current IM is constrained to remain substantially constant in amplitude. The secondary-side short circuit present during the interval from t₄ to t₅ prevents the magnetizing current from being reflected to the primary side. Consequently, the magnetizing current is unable to further discharge the parasitic capacitance reflected across the main power switch Q1, thereby preventing the voltage across Q1 from transitioning to zero prior to turn-on. Zero-voltage switching (ZVS) of the main power switch Q1 cannot be achieved under conditions of negligible leakage inductance.

One prior approach to address this limitation was enabled resonant voltage transitions, but it introduced additional hysteresis losses associated with the nonlinear magnetic core, reducing overall efficiency and increasing magnetic complexity. The short circuit formed on the secondary side by the simultaneous conduction of SR2 and SR1 (via its body diode) inhibits further reduction of the voltage across Q1 toward zero. This secondary-side short circuit maintains the magnetizing current at a substantially constant level and prevents the transfer of magnetizing energy to the primary side for discharging the parasitic capacitance of Q1. As a result, ZVS operation is not attainable. This limitation is inherent in forward-derived converter topologies wherein a secondary-side short circuit is formed by the conduction of synchronous rectifiers during the commutation interval, particularly in converters employing transformers with very high coupling coefficients and negligible leakage inductance.

Another prior approach to address this limitation was using a nonlinear magnetic element in series with the forward rectifier on the secondary side. While this method enabled resonant voltage transitions, it introduced additional hysteresis losses associated with the nonlinear magnetic core, reducing overall efficiency and increasing magnetic complexity.

This specification discloses multiple embodiments that enable zero-voltage switching in forward converters employing transformers with very small or negligible leakage inductance, without requiring nonlinear magnetic elements in the secondary circuit and without incurring additional hysteresis losses.

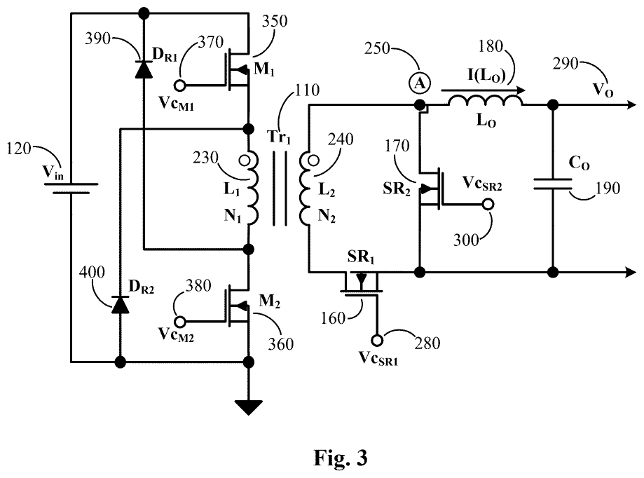

FIG. 3 illustrates a basic schematic of a single-ended, two-transistor forward converter topology. The converter includes two primary switching devices M1 (350) and M2 (360), which are operated simultaneously. Also included are two reset diodes DR1 (390) and DR2 (400), which perform multiple functions within the topology.

One function of reset diodes DR1 (390) and DR2 (400) is to reset the transformer Tr (110) by applying the input voltage Vin (120) across the primary winding with a polarity opposite to that present during the conduction interval of M1 (350) and M2 (360). Another function of reset diodes DR1 (390) and DR2 (400) is to provide a conduction path that allows the energy stored in the leakage inductance of the transformer to be transferred back to the input voltage source.

On the secondary side, the converter includes two rectifying elements SR1 (160) and SR2 (170), and an output filter formed by an output inductor Lo(180) and an output capacitor Co (190).

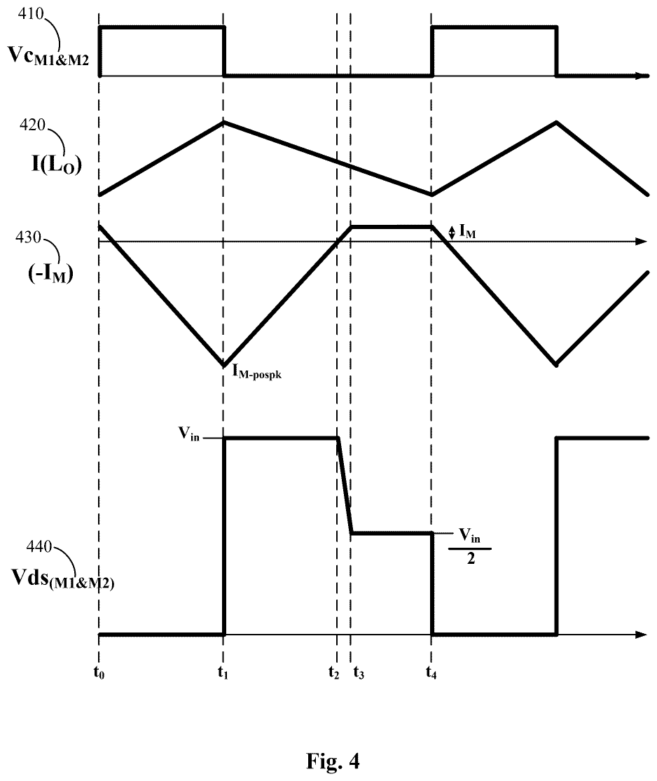

Operating waveforms of the two-transistor forward converter are shown in FIG. 4. The waveforms are: VcM1&M2,410, the control signal for M1, and M2, I(Lo), 420, which represents the current through the output inductor Lo, the (−IM), 430, which represents the magnetizing current in the transformer Tr1, 110, and Vds(M1&M2), 440, which represents the voltage across M1 and M2.

FIG. 4 identifies four intervals. Between t0 to t₁, the main primary switch M1, 350, and M2, 360, are on and during this time the current through Lo increases, time wherein energy is stored in Lo,180, and some energy is transferred to the secondary towards Co, 190, and Rload. During the conduction of M1, 350, and M2, 360, the magnetizing current in the transformer increased between t0 to t₁. The magnetizing current is presented in FIG. 4 multiplied by (−1), as (−IM). The purpose for this inversion is to make a visual comparison between the current through the output inductor I(LO), 420, and (−IM), 430, as depicted in FIG. 4.

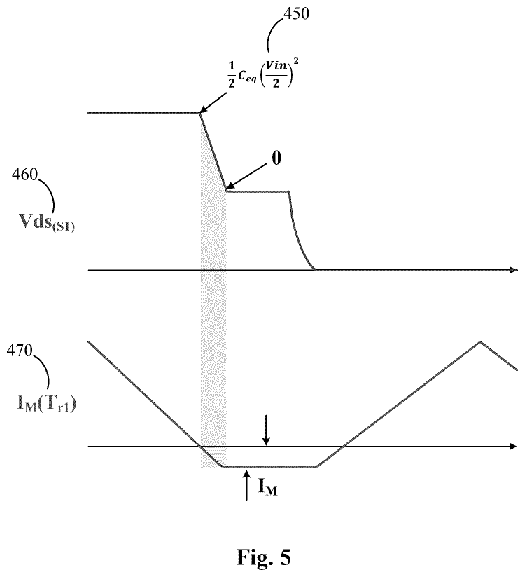

In between t₁ to t₂ is the reset period of the transformer Tr1,110, and the magnetizing current (−IM),430, reaches zero at t₂. In between t₂ to t₃ the voltage across M1, 350, and M2, 360, start decaying from an amplitude which is Vin,120, to Vin/2. In FIG. 5 is presented the voltage across the switching elements M1, 350, and M2, 360, during this transition and the magnetizing current during the same transition from Vin, 120, to Vin/2 section, interval which is shaded.

The difference of the energy contained in the parasitic capacitances before and after the transition is converted in magnetizing current energy defined by IM, 430.

In between t₃ to t₄ from FIG. 4, is the dead time period wherein no energy is processed.

The negative component of the magnetizing current flows into secondary as depicted in FIG. 1, flowing into the node A. while the output current I(Lo), 420, flows from the point A towards to Lo and the output. By depicting the (−IM) rather than (IM) gives us visually representation of the currents going in and out of the switching node A. The negative portion of the magnetizing current goes into the switching node A, flowing from the secondary winding L2, 240, and the current through Lo, 180, flows out of the switching node A, 250, for a positive polarity of the current through Lo, 180.

A new terminology is introduced herein, in which the “positive” magnetizing current IM-poz, is the magnetizing current which is increasing during the conduction of the main primary switchers M1,350, and M2, 360, and the “negative” magnetizing current IM-neg whose absolute amplitude decreases during the conduction of DR1, 390, and DR2, 400.

Between t1 to t2, the reset diode DR1, 390, and DR2, 400, conducts the magnetizing current is resetting the transformer TR1, and in process the magnetizing current decreases its amplitude from IM-neg-pk at t1 to zero at t2.

In FIG. 5 is depicted the voltage across the primary switching elements and the magnetizing current through the transformer. As can be seen when the voltage across the primary switching elements decays from the Vin level to Vin/2, visualized by the shaded area, and the magnetizing current becomes negative. The negative value of the magnetizing current represents the energy obtained from the energy parasitic capacitance across the switching elements decaying from Vin to Vin/2. The negative magnetizing current IM presented in formula (3).

$${I}_{M} = \frac{N * {V}_{0}}{\sqrt{\frac{{L}_{1}}{{C}_{eq}}}} \qquad ( 3 )$$

where IM is the magnetizing current;
N is the turns ratio in the transformer;
L1 is the inductance of the primary winding of the transformer; and
Ceq is the parasitic capacitance reflected across the primary switching elements.

The negative magnetizing current is proportional with the input voltage, and the primary inductance and equivalent parasitic capacitance Ceq which is further defined by the formula (4) which means that the equivalent parasitic capacitance is the summation of the parasitic capacitance across each primary switching device and the parasitic capacitance reflected across the primary winding.

$${C}_{eq} = {C}_{oss ( {M}_{1} )} + {C}_{oss ( {M}_{2} )} + {C}_{Trp} \qquad ( 4 )$$

where Coss(M1) and Coss(M2) is the parasitic capacitance across M1,350, and M2, 360; and
CTrp is the parasitic capacitance reflected across the primary of the transformer Tr1, 110.

In between t₂ to t₃ the energy contained in the parasitic capacitance across the switching elements in the primary is converted in the magnetizing energy.

In between t₃ to t₄ the magnetizing inductance is shorted in the secondary side by the conduction of SR2, 170, which conducts the current through the output inductor, I(Lo), 420, and the body diode conduction of SR1. The secondary short circuit previously described is also the reason that zero voltage switching cannot be obtained by the use of the magnetizing current in applications with very low leakage inductance.

### ZVS in Two Transistors Forward Topology by Employing the Negative Magnetizing Current

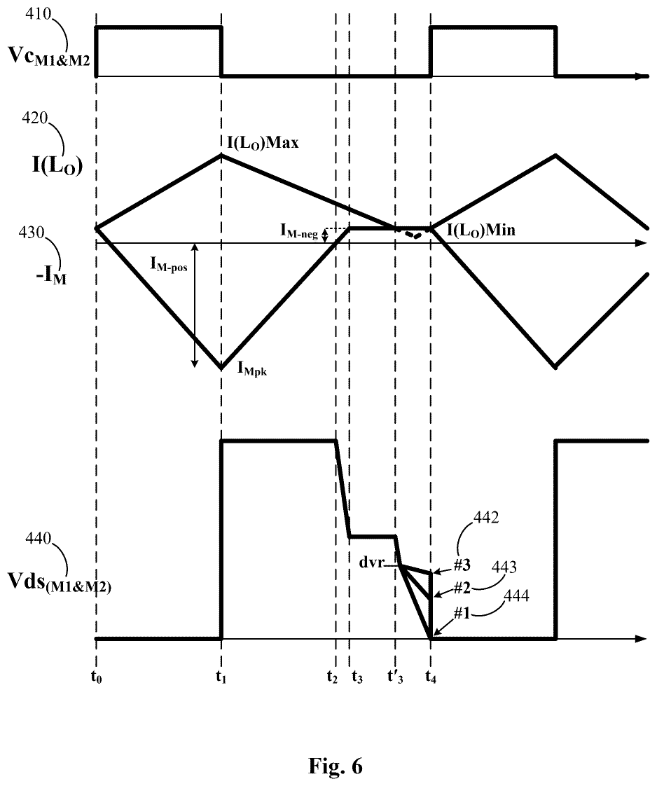

FIG. 6 presents waveforms in the Single Ended Two Transistor topology from FIG. 3, at lighter loads.

At lighter loads the output current through Lo has a lower amplitude and the min current through Lo, I(Lo)Min reaches the amplitude of IM-neg at t3′. That changes the mode of operation after t3′. At t3′ the magnetizing current flowing from the secondary winding into the switching node A has the same amplitude as the current through Lo. That means that the current demanded by Lo is fully provided by IM-neg and the current through SR2 becomes zero. Once the current through SR2 is zero the SR2 can be turned off That opens the secondary short circuit as previously presented. After t3′ once the current through Lo decreases, the extra current of IM-neg flows back into the primary and starts discharging the parasitic capacitances across M1 and M2.

As is visible in FIG. 6, immediately after after t3′ the voltage decays in a resonant way due to the energy of the leakage inductance which partially discharges the parasitic capacitance across M1 and M2, by an amount of dVr. After that there are presented 3 curves, #1, #2 and #3 which represents the discharge of the parasitic capacitances across M1, 350, and M2, 360, by the magnetizing current which is transferred back into the primary side. The voltage decay of the parasitic capacitance across M1, 350, and M2, 360, is function of the difference in between the magnetizing current reflected into the secondary and the current through output inductor. The current difference between the magnetizing current reflected in the secondary and the current through the output inductor, reflects back into the primary side and discharge the parasitic capacitance across M1 and M2. In the case of curve #3 the difference in between the magnetizing current reflected into the secondary and the current through Lo is relatively small while in the case of curve #1 there is a larger current difference which is reflected into the primary and discharge the parasitic capacitances to zero at t₄. This method does work in applications wherein IM-neg which is presented in equation (3) is larger than the minimum current through the output inductor.

ZVS in Forward with Active Clamp Topology by Employing the Negative Magnetizing Current

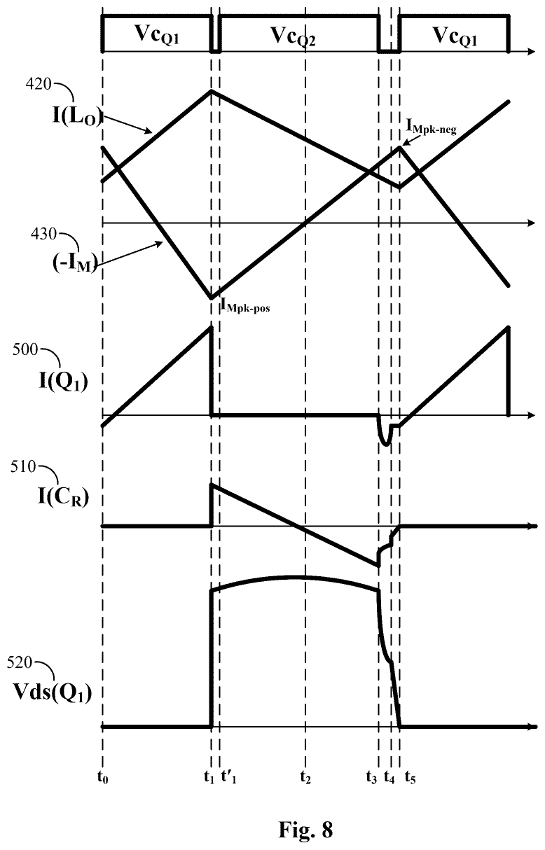

In FIG. 1 a single ended forward with active clamp topology is presented. FIG. 8 presents waveforms from the circuit in FIG. 1. They depict the control signal for Q1, VcQ1,130, and M2, Vc(Q2), 270, the current through the output inductor Lo, I(Lo),420, the magnetizing current, (−IM), 430, the current through M1, I(Q1),500, the current through the clamp capacitor CR, I(C_{R}), 510, and the voltage across Q1, Vds(Q1), 520.

FIG. 8 identifies the following time intervals of operation.

Between t0 to t₁, the main switch Q1 is on and the current builds up via the primary winding, L1,230, and the main switch Q1, 140, as depicted by I(Q1), 500. During this time, in a forward mode, the current is induced in the secondary winding via SR1,160, and the output inductor Lo,180, which is also depicted by the I(Lo), 420. During this time the flux density amplitude builds up in the transformer Tr1, depicted by the (−IM),430. At t₁ the main switch Q1,140, turns off.

Between t1 to t1′ the voltage builds up across the main switch Q1 via the body diode of Q2, 130, and the clamp capacitor C_{R},150.

At t1′ the second switch Q2,150, referred also as clamp switch is turned on. The magnetizing current flows via Q2, 130 and C_{R}.

The active clamp is also known as the “current mirror”, wherein the magnetizing current looks like is reflected by the CR capacitor, wherein the magnetizing current amplitude is changing linearly from t₁ to t₃, reaching zero amplitude at t₂ and its peak, IMpk-neg, at t₅.

At t₃ the switch Q2 is turned off and the magnetizing current has a negative polarity flowing through parasitic capacitance of Q2, from source to drain, through the primary winding of the transformer Tr1, 110, and further to the input voltage. The leakage inductance current and magnetizing current IM is discharging the parasitic capacitance of Q1 between t₃ to t₄ as depicted by Vds(Q1),520. When the voltage across Q1 decays under Vin level, the polarity of the voltage across the secondary winding L2, changes and the current starts flowing through the body diode of SR1, 160, and SR2,170, which was conducting the current through Lo. The leakage inductance current and the magnetizing current flowing through C_{R} at t₃ discharges the parasitic capacitance across Q1 between t₃ to t₄ in a resonant way.

It is noticeable comparing the (−IM) from FIG. 4 and the magnetizing current from FIG. 8 which represents the magnetizing current of the single ended forward with active clamp, that the negative magnetizing current amplitude has the same amplitude of the positive magnetizing current and IMpk-poz is larger than the current through Lo, I(Lo),420. As a result, the difference between the magnetizing current and output current in between t₄ to t₅ reflects back into the primary winding of the transformer Tr1,110, and it discharges the parasitic capacitance across Q1,140, linearly between t₄ to t₅ towards zero and reach zero at t₅. To obtain ZVS from the circuit presented in FIG. 1 and its waveforms in FIG. 8, the inequation (5) has to be satisfied.

$${I}_{M} > ( {I}_{M} - \frac{1}{2} * \frac{{V}_{O} ( 1 - D )}{{L}_{O} * Freq} ) \qquad ( 5 )$$

where IM is the magnetizing current reflected in the secondary defined by equation (2);
Vo is the output voltage;
D is the duty cycle of operation;
Lo is the inductance of the output choke, Lo; and
Freq is the frequency of operation for the converter.

The ZVS method, in which the ZVS is obtained when the conditions from (5) are satisfied, also works in other topologies such as half bridge and full bridge.

Two Transistors Forward with Active Clamp Topology

FIG. 11 presents two transistors forward topology with active clamp and shorting switch circuit. FIG. 11 contains two switching devices M1, 1100, and M2, 1110, placed at one end and the other end of the primary winding, L1 of the transformer Tr1. Across the primary winding L1 a clamp circuit formed by Cc1,1160, and M_{L},1150. The clamp circuit has the role of resetting the transformer as the active clamp from FIG. 1. In addition to the active clamp formed by Cc1,1160, and M_{L},1150, there is a shorting switch formed by Dc,1130, and Mc,1178. The role of the shorting switch is to create a low impedance path for the magnetizing current during the dead time when neither M1,1100, and M2,1110, do conduct. In addition to that the circuit from FIG. 11 the voltage across the primary transformer is shared by two switching elements M_{L},1150, and Mc,1178. In some applications an additional voltage source Vinj,1120, is placed in order to increase the amplitude of the magnetizing current as needed.

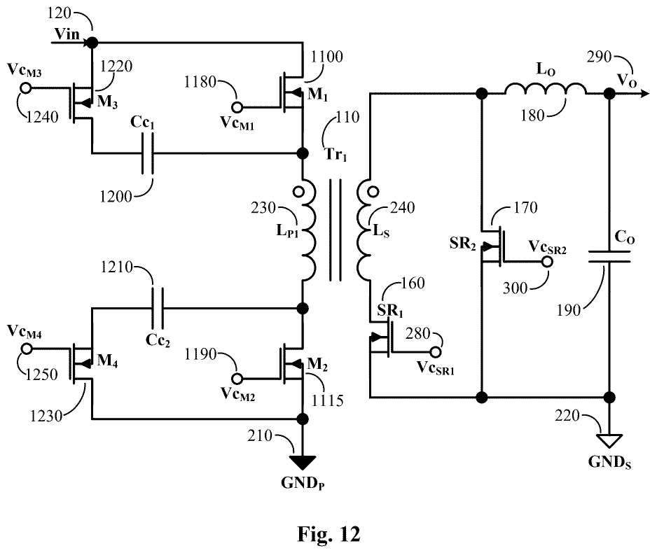

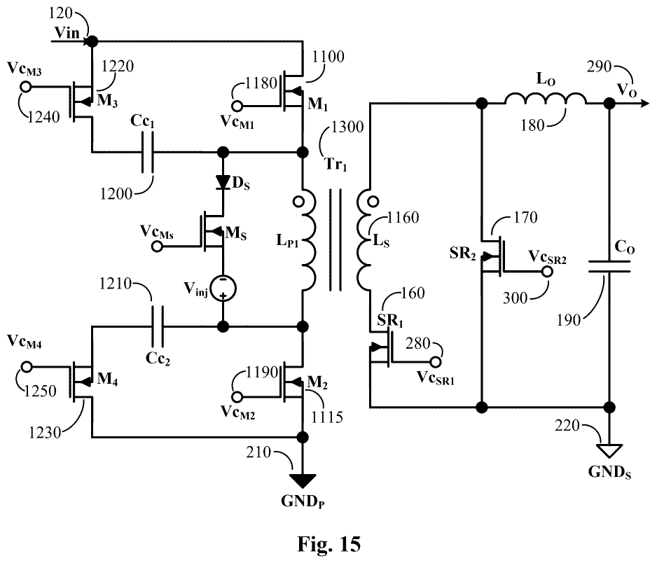

A further embodiment of the circuit presented in FIG. 11 is the circuit from FIG. 12. In FIG. 12 a symmetrical structure is presented with two active clamp circuits. The first active clamp circuit placed across M1,1100 is formed by M3,1220, and C_{c1}, 1200, and the second active clamp circuit across M2, 1115, is formed by M4, 1230, and C_{c2}, 1210. In the circuit depicted in FIG. 12 there is not a shorting switch as FIG. 11. In some applications as depicted in FIG. 15 the shorting switch Mc, 1178, in series with Dc, 1130, and Vinj, 1120, is placed across the primary of the transformer Tr1, 1300. In certain conditions wherein the magnetizing current does not have the amplitude to exceed the current through the output choke, the Vinj creates the amplitude for zero voltage switching on the primary switchers at turn on. This method of energy injection is also referred to as voltage injection.

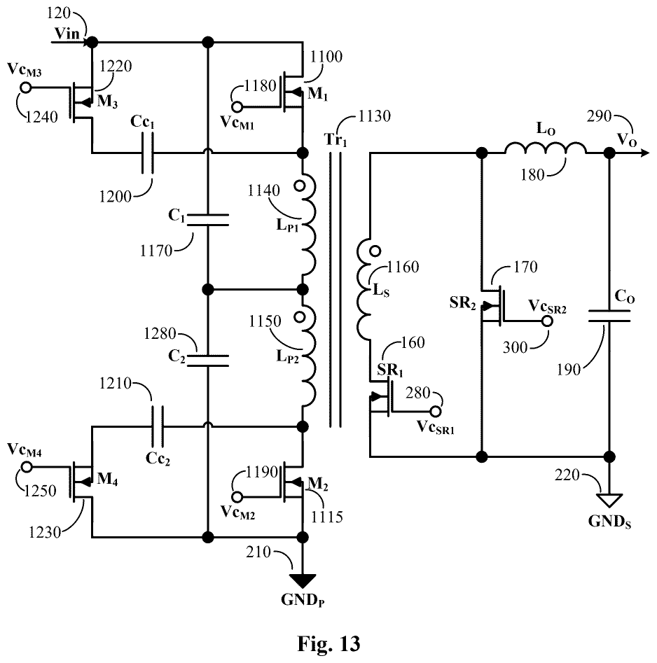

In FIG. 13 is presented a further embodiment for the circuit from FIG. 12. In FIG. 13 two capacitors C1, 1170, and C2, 1280, are placed in series and across the primary voltage source Vin, 120, and the common connection of C1,1170 and C2, 1280 is connected to the middle of the primary winding.

These circuit modifications is to ensure that the middle point of the primary winding does not move during the switching operation. In two transistors forward in perfect symmetry the middle of the primary winding does not move and as a result when the secondary winding is placed in between Lp1, 1140, and Lp2, 1150, there is not common mode injected from the primary to secondary. However, there is not such thing as perfect symmetry. The presence of the C1, 1170, and C2, 1280, is to ensure that there is not common mode noise injected from the primary winding into the secondary winding in the event wherein the secondary winding is placed in between Lp1, 1140, and Lp2, 1150. In addition to that any asymmetry in driving circuits for M1 and M2 is, to a certain extent, compensated for by the capacitors C1 and C2.

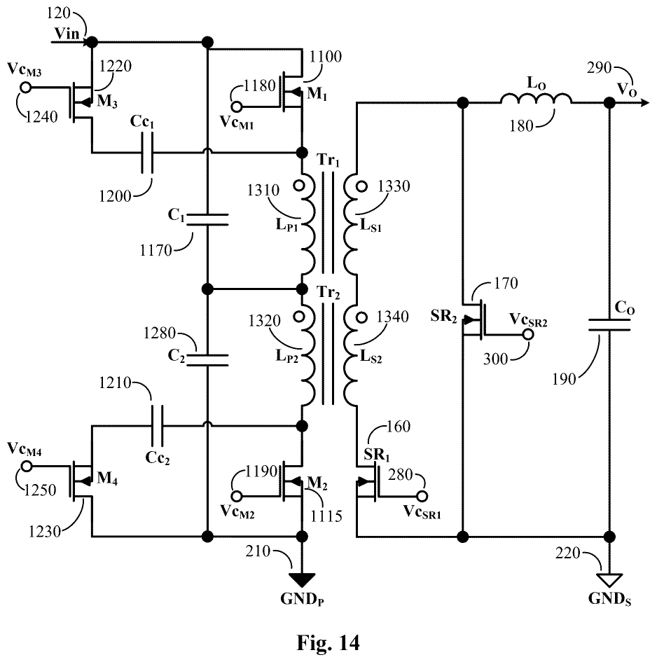

Another circuit based on the dual clamp circuit concept is depicted in FIG. 14, wherein there are two transformers Tr and Tr2 with the secondary windings LS1 and LS2 are in series to ensure that the primary windings LP1 and LP2 have the same current and the middle point in between C1 and C2 is maintained balanced.

In FIG. 15 the circuit has an additional short circuit subcircuit formed by Ds, Ms, and Vinj, subcircuit which is connected across the primary winding. The purpose of Vinj is to increase the magnetizing current as needed in order to satisfy the equation (5).

The circuits depicted in FIG. 11, 12, 13 14 and 15 combine advantages of the active clamp and advantages of the two transistors forward configuration which reduces the voltage stress on the primary switching elements.

The active-clamp solution illustrated in FIG. 11 provides certain advantages, but also has several limitations. In particular, the active-clamp topology of FIG. 11 is highly sensitive to mismatches in delay time between the gate-drive signals applied to the primary switching elements M1 and M2. Additionally, the topology is highly sensitive to mismatches in the on-time durations of the switching elements M1 and M2. These sensitivities complicate practical implementation and may result in degraded performance, and reduced reliability.

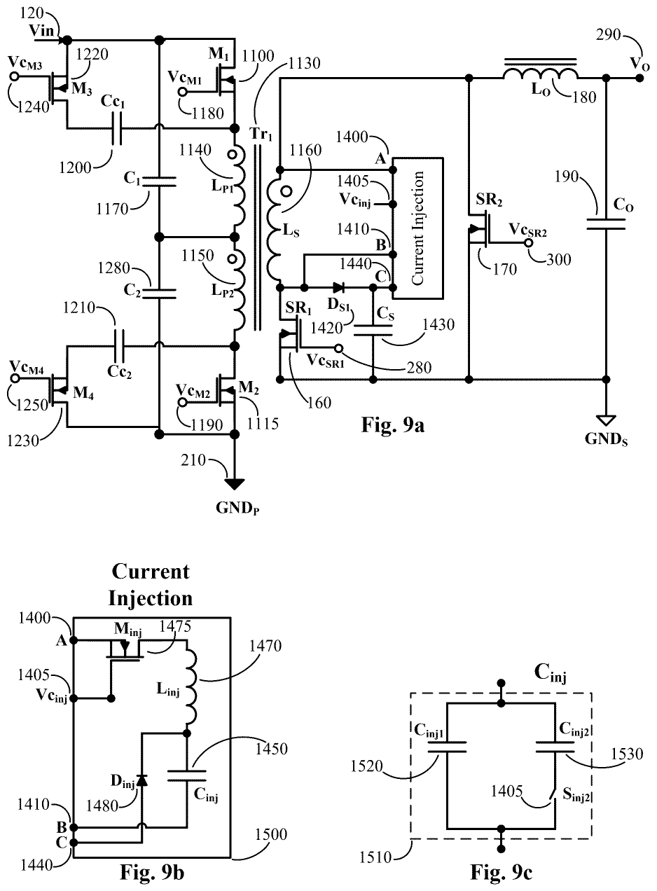

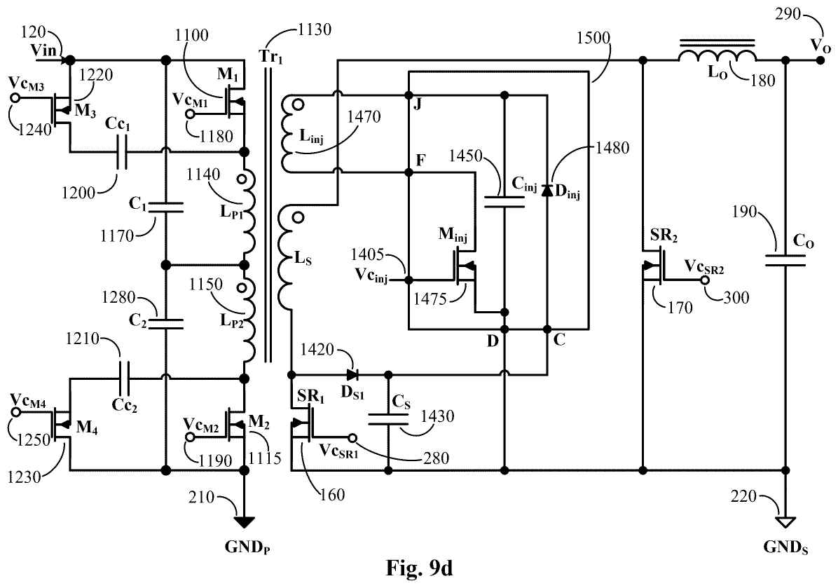

These limitations are addressed by the embodiments illustrated in FIGS. 12, 13, 14, and 15, as well as in FIG. 9(a). These embodiments illustrate a topology embodiment, referred to herein as a dual active-clamp two-transistor forward topology.

In the disclosed dual active-clamp configuration, each primary switching element is provided with a respective active-clamp circuit. Each active-clamp circuit includes a clamp capacitor and a clamp switch, wherein the clamp switch is driven by a control signal complementary to the control signal of the associated primary switching element. By providing an independent active clamp for each switching device, the disclosed topology significantly reduces sensitivity to mismatches in gate-drive signal delay and on-time between the primary switching elements.

Accordingly, the dual active-clamp two-transistor forward topology improves tolerance to gate-drive timing variations, enhances operational robustness, and improves overall performance and reliability compared to conventional active-clamp two transistor forward converter implementations.

FIGS. 13, 14, and 9(a) illustrate another embodiment. In very high input-voltage applications, for which the disclosed converter topologies are particularly suitable, the voltage across the primary switching elements exhibits a high rate of change (dv/dt). Under such operating conditions, common-mode (CM) noise becomes a significant concern for system designers. This issue is further amplified in applications employing planar transformers.

In planar transformer implementations, the interwinding capacitance between the primary winding and the secondary winding is typically higher than that of conventional wire-wound transformers due to the geometric overlap and proximity of the windings. As a result, high dv/dt switching transitions produce increased displacement currents, which in turn generate elevated levels of common-mode noise. This phenomenon is particularly problematic in topologies such as full-bridge phase-shifted converters, which are commonly used in high-voltage and high-power applications.

The two-transistor forward topology provides a preferred but not critical advantage with respect to common-mode noise reduction due to its inherent electrical symmetry. When the primary switching elements are turned on, both terminals of the primary winding transition in opposite voltage directions, while the electrical midpoint of the primary winding remains substantially stationary. If the secondary winding is positioned symmetrically with respect to this midpoint, the resulting common-mode voltage coupled to the secondary is substantially reduced.

As illustrated in FIG. 13, the midpoint of the primary winding is tapped and coupled to two substantially identical capacitors C1 and C2. In many implementations, a damping resistor Rd (1175) is connected between the midpoint of the transformer and the common connection of capacitors C1 and C2. This configuration further attenuates residual common-mode noise components.

Although the secondary winding terminals still experience voltage movement relative to the primary midpoint, the resulting common-mode noise is significantly reduced, particularly in low-output-voltage applications. To further suppress or substantially eliminate common-mode noise, one or more primary winding layers connected to the midpoint are arranged symmetrically above and below the secondary winding layers. These symmetrically placed primary windings function as an electrostatic shield between the primary and secondary windings, thereby reducing capacitive coupling.

In a multilayer printed circuit board (PCB) planar magnetic structure, a secondary winding is disposed on at least one internal layer, and a first primary winding is disposed on a layer located above the secondary winding while a second primary winding is disposed on a layer located below the secondary winding. The first and second primary windings each include one or more turns arranged in geometrical symmetry with respect to the secondary winding, such that a displacement current formed between the secondary winding and the first primary winding has substantially the same magnitude and an opposite phase relative to a displacement current formed between the secondary winding and the second primary winding, thereby reducing net capacitive coupling and common-mode current.

In a multilayer PCB planar magnetic structure, the layer above and below the layers containing secondary winding shall have one or more turns in perfect symmetry in such way that the displacement current in between the secondary windings and the windings placed on the primary layer placed on top have the same amplitude but opposite phase in relation to the displacement current in between said primary windings located on the layer bellow.

This symmetric winding arrangement and midpoint-referenced clamping structure is one advantage of the two-transistor forward topology and represents one of the embodiments of the specification. By combining inherent primary-side symmetry with optimized planar winding placement, the disclosed embodiments significantly reduce common-mode noise without the need for additional shielding layers or external common-mode filtering components.

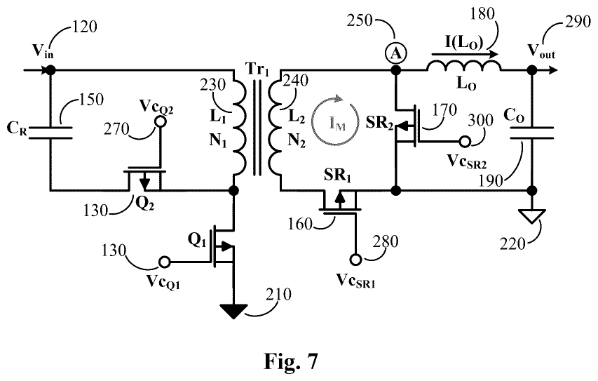

FIG. 7 presents a dual clamp two transistors forward topology having in the secondary two sets of secondary switching elements, each set formed by a freewheeling synchronous rectifier and an inductor, such as the first set is formed by SR2A and LOA and the second set is formed by SR2B and LOB. The secondary can contain any number of secondary switching elements. The purpose of this embodiment is to split the current through a multitude of output inductors and a multitude of synchronous rectifiers. Through secondary synchronous rectifiers can be placed in parallel to handle a larger amplitude of output current, that may be more challenging in paralleling output inductors due to many secondary effects. Placing in parallel several sets of output inductors each one with its own synchronous rectifier will generally ensure better operation in higher output current applications.

ZVS in TT Forward with Active Clamp Topology and Current Injection

Applying a current-injection technique in connection with a full-bridge phase-shifted converter topology in the two transistor forward topology, under operating conditions such as heavy load, wherein IM(t)>Io(t) cannot be satisfied prior to the primary switchers M1 and M2 turn on, a current-injection winding that is magnetically well coupled to both the primary winding and the secondary winding is used to inject an auxiliary current pulse to add to the magnetizing current of the transformer. The injected current pulse is superimposed over the magnetizing current and reaches an amplitude that exceeds the current flowing through the output inductor.

When the sum of the magnetizing current and the injected current pulse exceeds the output-inductor current, the current through synchronous rectifier SR2 (170) is driven to zero, thereby forcing SR2 (170) to turn off. The difference between the combined magnetizing and injected currents and the output-inductor current is reflected into the primary winding and referred to as I_{RP}, 1111. This reflected current is used to discharge the parasitic capacitances associated with the primary switching elements M1 (1100) and M2 (1115) to substantially zero voltage, thereby enabling zero-voltage switching of the primary switches.

In this specification, there is an improved configuration that not only ensures zero-voltage switching (ZVS) of the primary switching elements under heavy-load operating conditions, but also addresses a significant limitation inherent to conventional single-ended forward converters—namely, the voltage spike appearing across synchronous rectifier SR1 (160) during turn-off of the primary switching elements M1,1100, and M2,1115. Further, in at least one embodiment, the disclosed current-injection functionality is implemented without requiring an additional winding in the transformer.

In this embodiment, a current-injection methodology is employed to ensure zero-current switching (ZCS) of synchronous rectifier SR2 (170), even under operating conditions in which the inequality I_{M}(t)>I(Lₒ) is not fully satisfied. By enabling ZCS of SR2 (170) under such conditions, the required amplitude of the transformer magnetizing current is reduced.

The reduction in magnetizing current amplitude enables a corresponding reduction in the current ripple through the output inductor Lₒ. As a result, conduction losses within the converter are reduced. In addition, the reduced current stress leads to lower core losses in both the transformer and the output inductor, thereby improving overall efficiency, thermal performance, and reliability of the converter.

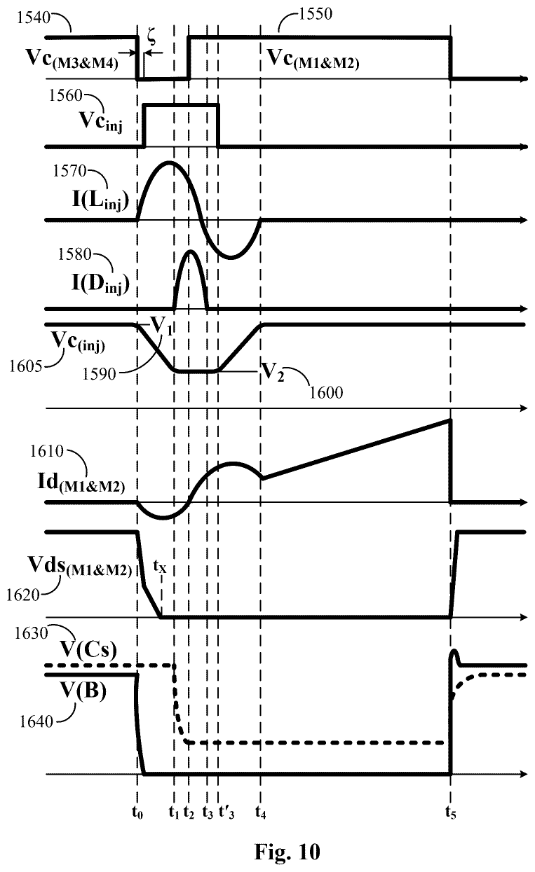

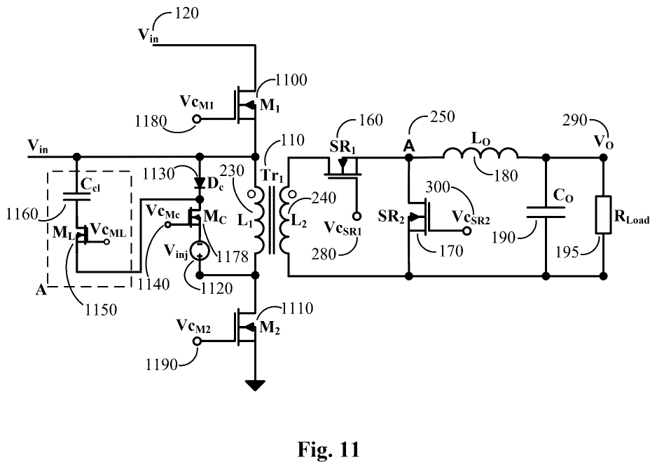

The current-injection methodology is illustrated in FIGS. 9(a), 9(b), and 9(c), as well as in FIG. 10.

In one embodiment, the current-injection functionality is implemented using an additional winding magnetically coupled to the primary winding and the secondary winding of the transformer. In an alternative embodiment, the current-injection functionality is achieved without the use of an additional transformer winding, using the secondary winding in combination with a separate inductive element configured to provide the required current-injection function.

In some topologies, there is a zero-voltage-switching (ZVS) technique for DC-DC converters in which a resonant current is generated by a switching element connected in series with a resonant capacitor arranged in parallel with a diode, together with a resonant inductor positioned at a switching node. In such topologies, the resonant current is injected into the switching node to forcibly drive current through one or more switching devices in order to discharge their parasitic capacitances and thereby obtain ZVS. A disadvantage of this solution is that the resonant current must have a relatively large amplitude in order to independently force the switching device current to exceed the output current. As a result, the resonant current exhibits a high RMS value, leading to increased conduction losses, higher current stress in the resonant components, and reduced overall efficiency, particularly at medium and high power levels.

In contrast, in the embodiments disclosed herein, and particularly in the embodiment illustrated in FIG. 9(b), the injected current is not required to independently exceed the current of the switching device in order to achieve zero-voltage switching. Instead, the injected current has a relatively small amplitude and is intentionally combined with the transformer magnetizing current. Only the sum of the magnetizing current and the injected current is sufficient to achieve zero-current switching (ZCS) of a switching device, which in turn enables zero-voltage switching (ZVS) of the primary switching elements.

In the present specification, the current-injection circuit is activated only under specific operating conditions, such as heavy-load operation. Under light-load or nominal operating conditions, the current-injection circuit operates with reduced amplitude or remains inactive, thereby minimizing RMS current stress and conduction losses.

Furthermore, in the embodiments illustrated in FIGS. 9(a) and 9(b), the current-injection diode Dinj is not connected in parallel with the current-injection capacitor Cinj. Instead, the current-injection diode Dinj is configured to extract energy from a clamp capacitor associated with the secondary-side clamp circuit. This extracted energy is used to suppress voltage spikes that would otherwise occur in the absence of the loading effect provided by the diode Dinj.

As a result, the disclosed current-injection circuit performs a dual function: (i) selectively providing supplemental current to enable zero-current switching through SR2m 170, under heavy-load conditions, and (ii) extracting and recycling clamp energy from Cs, 1430, from FIG. 9a to suppress voltage spikes and ringing. In addition, because the injected current is a combination of a resonant component and an energy-extraction component, the negative resonant current has a lower amplitude than the positive resonant current. Consequently, the RMS current flowing through the current-injection circuit is substantially lower than in other resonant injection schemes.

FIG. 9(a) illustrates the circuit of FIG. 13 further incorporating a current-injection circuit. The current-injection circuit module, 1500, is electrically connected to both ends of the secondary winding at nodes A (1400) and B (1410). A clamp circuit is coupled across synchronous rectifier SR1 (160), the clamp circuit including a clamp diode Ds1,(1420), and a clamp capacitor Cs, (1430).

A common node formed between the clamp capacitor Cs and the clamp diode Ds1 is electrically connected to an input node of a current-injection module, designated node C (1440). In conclusion, the current-injection module (1500) is electrically coupled to the power-conversion circuitry of FIG. 13, through interconnection nodes A (1400), B (1410), and C (1490) as is depicted in FIG. 9a.

The current-injection module (1500) further includes a control input signal Vcinj (1560), from FIG. 10, which provides a control signal for a current-injection switch Minj (1475) disposed within the module. The Vcinj, is associated with the pin 1405 of the current injection moule.

FIG. 9(b) illustrates one embodiment of the current-injection module (1500). The current-injection module includes the current-injection switch Minj (1475), which is controlled by the control signal Vcinj (1460) and Minj(1475) is electrically connected to node A (1400). The module further includes a current-injection inductor Linj (1470), a current-injection capacitor Cinj (1450), which is electrically connected to node B (1410), and a current-injection diode Dinj (1480), which is electrically connected to node C (1440).

The elements of the current-injection module collectively form a current-injection network configured to selectively inject current into the secondary-side circuit in response to the control signal Vcinj, thereby enabling soft-switching operation and reducing voltage stress on circuit components as described herein. The current injection switch ensures that I_{M}(t)+I(Linj)>I(Lₒ).

In between t₀ to t₁, the injected current I(Linj), in combination with the transformer magnetizing current I_{M}, exceeds the current flowing through the output inductor I(Lₒ). As a result, the current through synchronous rectifier SR2 (170) is driven to zero, thereby forcing SR2 (170) to turn off under zero-current switching (ZCS) conditions.

By ensuring zero-current switching (ZCS) of synchronous rectifier SR2 independently of whether the inequality I_{M}(t)>I(Lₒ) is satisfied.

The disclosed current-injection methodology enables reduced magnetizing current amplitude, reduced output-inductor current ripple, and reduced current stress in the power-conversion circuitry. Consequently, conduction losses and magnetic core losses are reduced, while overall efficiency, reliability, and electromagnetic performance of the converter are improved.

The current reflected into the primary discharges the parasitic capacitances reflected across M1 and M2 to zero at tx.

At time t₂, the main switching devices M1 and M2 are turned on at zero voltage switching conditions.

The current injection in addition to the magnetizing current IM, exceeds the current through the output choke, I(Lo). As a result, the current through SR2, 170, becomes zero creating zero current (ZCS) switching conditions through SR2, 170.

(IM+Iinj)−I(Lo)=I_{RP}
wherein I_{RP} represents a current reflected to the primary side of the transformer. The reflected current IRP discharges the parasitic capacitances reflected across the primary switching elements M1 and M2, thereby establishing zero-voltage switching (ZVS) conditions for M1 and M2. These ZVS conditions as previously mentioned, are achieved after the time tx.

The current-injection current I(Linj),1570, continues to discharge the current-injection capacitor Cinj,1450, until the voltage across Cinj,1450, reaches a voltage level V2 (1600) at time t1. The voltage level V2(1600) is substantially equal to the voltage across the clamp capacitor Cs (1430).

At time t2, the primary switching elements M1 and M2 are turned on under zero-voltage conditions previously established at time tx. After the voltage across Cinj reaches the voltage level V2(1600), the current-injection I(Linj), 1570 supplied through the current-injection diode Dinj (1480) from the clamp capacitor Cs (1430). The current through the current-injection diode, denoted I(Dinj), 1580, decreases and reaches zero at time t₃. Simultaneously, the current-injection current I(Linj) (1570) also reaches zero.

After the current-injection current I(Linj) reaches zero at time t₃, the polarity of I(Linj), 1570, reverses and becomes negative. This negative current flows through the current-injection inductor Linj and into the current-injection capacitor Cinj, thereby charging Cinj, 1450. The energy used to charge Cinj during this interval is derived from the input voltage, and the charging process occurs in a forward resonant mode. This charging interval ends at time t₄ when the voltage across Cinj, reaches the value V1,1590.

During the charging interval, the current-injection switch Minj (1475) conducts in a reverse direction to enable charging of the current-injection capacitor Cinj. At time t3′, the control signal Vcinj, 1560, becomes zero and the current-injection switch Minj, 1475 turns off. After time t3′, the resonant current charging the current-injection capacitor Cinj, 1450, flows through the body diode of the current-injection switch Minj, 1475.

At time t4, the resonant charging current reaches zero, thereby terminating the resonant charging cycle of the current-injection capacitor Cinj.

Between times t4 and t5, the current flowing through the primary winding of the transformer (1130) increases substantially linearly, as illustrated in FIG. 10.

At time t5, the primary switching elements M1 and M2 are turned off During this turn-off event, voltage spikes and ringing may appear across synchronous rectifier SR1 (160). The clamp circuit formed by the clamp diode Ds1,1420, and the clamp capacitor Cs,1430 operates to limit and clamp the voltage across SR1. The energy associated with the voltage spikes is stored in the clamp capacitor Cs (1430) and is subsequently extracted through the current-injection diode Dinj (1480) by the current-injection circuit. This recovered energy is then reused to support subsequent zero-voltage switching transitions of the primary switching elements.

Another method of implementing the current injection technique is illustrated in FIG. 9d. In the embodiments depicted in FIGS. 9a and 9b, the current injection function requires a discrete inductor element Linj connected in series with a current injection capacitor and a current injection switching element.

In the embodiment shown in FIG. 9d, a current injection winding Linj,1470, is magnetically coupled with the primary and secondary windings of transformer Tr,1130. In this implementation, the discrete inductor element Linj is effectively replaced by the leakage inductance between the current injection winding Linj,1470, and the primary and secondary windings of transformer Tr,1130.

By way of example, if the secondary winding Ls, 1160, of transformer Tr1, 1130, has one turn, the current injection winding Linj may also include one turn. In an implementation using a multilayer PCB transformer, the current injection winding Linj, 1470, can be formed on the same PCB layer as the secondary winding. As a result, the inductive element required for current injection is obtained without additional material cost.

The current injection module 1500B includes a current injection switching element Minj,1475, a current injection capacitor Cinj,1450, and a current injection diode Dinj,1480. Terminals J and F of the current injection module are coupled to the current injection winding Linj ,1470. The current injection capacitor Cinj,1450, is coupled at one terminal to Linj,1470, and at a second terminal to ground GNDs,220.

In this configuration, the current injection capacitor concept illustrated in FIG. 9c can be readily implemented by providing a small switching element coupled to GNDs,220, in series with a trimming capacitor network connected in parallel with Cinj,1450.

The current injection diode Dinj,1480, is coupled, as shown in FIG. 9a, to the clamp capacitor Cs,1430. The purpose of Dinj is to extract energy from the clamp circuit formed by Ds1 and Cs, and to deliver said energy to the current injection path that flows through Minj ,1475, and Linj,1470.

Reverse Power Transfer in Tt Forward with Active Clamp Topology

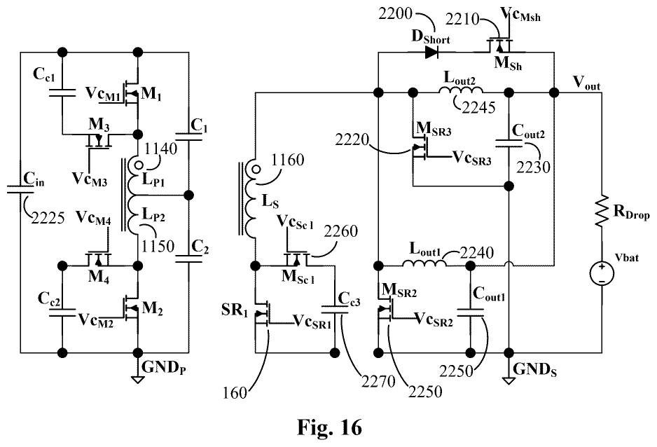

In automotive applications, the auxiliary battery charger in which the topology disclosed in this specification is employed must be capable of bidirectional power conversion. In addition to a forward operating mode in which electrical energy is transferred from a high-voltage input bus to a low-voltage auxiliary battery, the auxiliary battery charger is further configured to operate in a reverse power-transfer mode, wherein electrical energy is transferred from the low-voltage auxiliary battery to the high-voltage input bus. Such reverse power processing is required, for example, to support vehicle start-up, emergency operation, system redundancy, diagnostic functions, and energy redistribution within the vehicle electrical architecture. In FIG. 16, the reverse power transfer power from output to a big input capacitor(~1mF) for ZVS TT Forword topology is realized in two modes of operation.

Reverse Power-Transfer Operation—Mode 1. The reverse power transfer from the output side to a high-voltage input capacitor having a capacitance on the order of approximately 1 mF, for enabling zero-voltage switching (ZVS) operation of a two-transistor forward (TT Forward) topology, is implemented using two distinct modes of operation.

### Operating Mode 1:

In Operating Mode 1, the input capacitor is charged from an initial voltage of approximately 0 V to a voltage level of approximately k=0.5 to 0.8 (100V to 150V)., where n represents the effective transformer turns ratio and k is a scaling factor having a value in the range from 0 to approximately 0.8.

The scaling factor k is selected as a function of the operating condition of the system. In one embodiment, k is set to 0 to enable energy transfer from the output when the input capacitor is initially discharged, in which case additional secondary switching elements MSR2, 2255, and MSR3, 2220, are enabled. In another embodiment, when the input voltage has reached a stable intermediate level, k is selected in the range from approximately 0.5 to 0.8, corresponding to an input voltage range of approximately 100 V to 150 V.

During this first operating mode, a primary-side current flows from the output side toward the input capacitor through a current path including switching element M2,1115, primary inductances Lp1, 1140, and Lp2,1150, switching element M1, 1100, and the input capacitor Cin,2225. Concurrently, current from the output voltage is conducted through output inductors Lout1, 2240, and Lout2, 2245, switching element LS,1160, and synchronous rectifier SR1, 160.

Magnetic reset is achieved by routing a portion of the energy through clamp capacitor Cc3, 2270, clamp switching element MSc1, 2260, secondary inductance Ls,1160, and output inductors Lout1,2240, and Lout2,2245. The primary inductances Lp1,1140, and Lp2,1150, are magnetically coupled to the secondary inductance Ls via a transformer core, thereby enabling controlled energy transfer and magnetizing current reset during reverse power operation.

### Operating Mode 2:

In Operating Mode 2, the input capacitor is charged from the intermediate voltage level k·n·Vₒᵤₜup to a maximum voltage Vₘₐₓ. The primary current flows through switching element M2,1115, primary windings Lp1, 1140 and Lp2,1150, and switching element M1, 1100, thereby charging the input capacitor Cin,2225. The primary windings Lp1, 1140 and Lp2,1150 are magnetically coupled to the secondary winding LS,1160, through the transformer core.

On the secondary side, the circuits formed by Lout1, 2240 with MSR2,2250, and Lout2, 2245 with MSR3,2220, operate as boost circuits, storing energy in the output inductors. When switching element SR1, 160 is activated, the energy stored in Lout1,2240 and Lout2,2245 is released, and power is transferred from the secondary side to the primary side through the secondary winding LS,1160 and the coupled primary windings Lp1, 1140 and Lp2,1150, thereby further charging the input capacitor Cin,2225.

### Operating Mode 1:

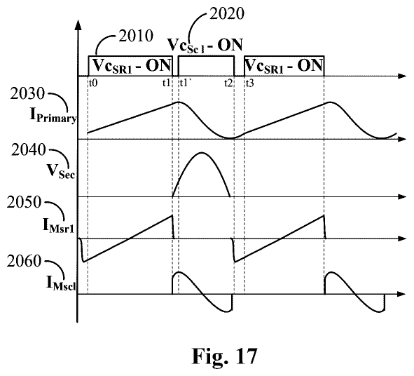

The time diagram corresponding to Operating Mode 1 is illustrated in FIG. 17. This operating mode represents the initial start-up condition in reverse power transfer operation, wherein the input capacitor Cin is initially discharged (V_Cin \textcircled{m}=0).

During this mode, the duty cycle of the secondary-side switching elements is initiated at approximately 50% and is progressively increased up to 75%. This controlled increase in duty cycle enhances the reverse power transfer from the secondary side to the primary side, thereby charging the input capacitor Cin. As a result, the voltage across Cin rises progressively from zero toward the predetermined intermediate voltage level.

The time sequence is depicted in FIG. 17:
t0-t₁: activate SR1 the secondary current start flows through the output inductors and secondary winding and transfer power in the primary side and charge the Cin through the M1, primary winding (Lp1&Lp2) and M2
t₁-t1′: MSR1 is turned off and the current continues to flow through the body diode of the MSc1, and the clamp capacitor Cc3.
t1′-t₂: MSR1 is turned off and is activated MSc1; the energy stored in the transformer and clamp capacitors continue to charge the input capacitor, by demagnetising the magnetic elements (transformer core and output inductors).
t₂-t₃: it is the dead time between MSc1 and MSR1; the current flow through the body diode of the MSR1

### Operating Mode 2:

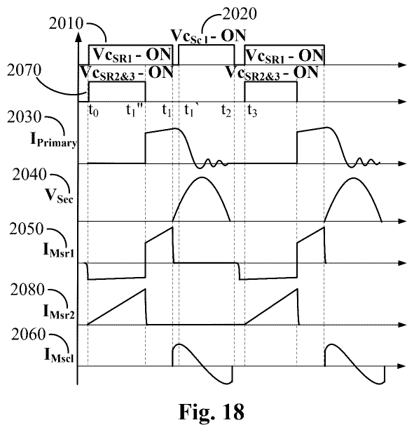

The time diagram corresponding to Operating Mode 2 is illustrated in FIG. 18. In this operating mode, the input capacitor Cin is pre-charged to a voltage level exceeding approximately 100 V (V_{cin}>100 V), and the secondary-side boost switching elements are activated to increase the current transferred into the input capacitor.

Once the input capacitor Cin is charged to an intermediate voltage level, determined by the output voltage and the applied duty cycle, the energy transferred through direct reverse power flow becomes insufficient to further increase the voltage across Cin. At this point, the secondary-side boost stage formed by switching elements MSR2 and MSR3, together with inductors Lout1 and Lout2, is activated. This boost operation increases the secondary-side energy level, enabling continued power transfer from the secondary side to the primary side and further charging of the input capacitor Cin toward its target voltage. t0-t1″: MSR1 is activated to provide a demagnetization path for the transformer core, while MSR2 and MSR3 are activated to boost energy in the output inductor.
t0-t₁″: MSR1 is turned on to establish a demagnetization path for the transformer core. Simultaneously, MSR2 and MSR3 are turned on to increase the energy stored in the output inductor.
t₁″-t₁: MSR2 and MSR3 are turned off, while MSR1 remains conducting. The energy stored in the output inductor is transferred to the primary side and charges the input capacitor Cᵢₙ through M1, the primary winding, and M2. The output-inductor current decreases during this interval.
t₁-t1′: MSR1 is turned off. The current continues to flow through the body diode of MSc1 and the clamp capacitor, thereby continuing to drive current into the primary winding.
t1′-t₂: MSc1 is turned on. The energy stored in the transformer magnetizing inductance and in the clamp capacitor continues charging the input capacitor until the clamp current reaches zero.
t₂-t₃: This interval represents the dead time between MSc1 and MSR1. Current flows through the body diode of MSR1 and the secondary winding, completing demagnetization of the transformer core

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. ADC-DC converter comprising:
(a) a primary side and a secondary side;
(b) an input voltage source coupled to the primary side;
(c) a transformer comprising at least one primary winding disposed on the primary side and having first and second terminals, and at least one secondary winding disposed on the secondary side, said primary winding and said secondary winding being magnetically coupled and defining a leakage inductance therebetween, wherein a magnetizing current flows in the transformer;
(d) first and second primary switching elements disposed on the primary side, each of the first and second primary switching elements being connected to a respective terminal of the input voltage source and to a respective terminal of the primary winding;
(e) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(f) an output inductor associated with each said set, the output inductor being coupled in series with a corresponding output capacitor, wherein the series connection of the output inductor and the output capacitor forms an output filter network coupled across the corresponding freewheeling switching element, and wherein an output load is coupled across the output capacitors of all said sets connected in parallel; and
(g) a first clamp circuit coupled across the first primary switching element and a second clamp circuit coupled across the second primary switching element, each of the first and second clamp circuits comprising a clamp switching element connected in series with a clamp capacitor;
(h) wherein each clamp switching element is controlled complementary to the corresponding primary switching element such that the primary switching element conducts while the corresponding clamp switching element is non-conducting, and vice versa, with a predetermined dead time between conduction intervals.

2. The DC-DC converter of claim 1, operating according to a method comprising:
(a) turning on the first and second primary switching elements, for a predetermined on time, thereby applying the input voltage to the primary winding of the transformer and causing a magnetizing current to build up in the transformer and an output current to build up in the output inductor;
(b) turning on the forward secondary switching element during said predetermined on time, to transfer energy to the secondary side;
(c) after said predetermined on time, turning off the first and the second primary switching elements;
(d) after a first predetermined first dead time, turning on the clamp switching elements, thereby providing a current path for the magnetizing current;
(e) allowing the output current to flow through a body diode of the freewheeling switching element and subsequently turning on the freewheeling switching element after a second predetermined dead time;
(f) allowing the magnetizing current flowing in the secondary winding to exceed the current drawn by the output inductor, thereby forcing the current through the freewheeling switching element to reach zero and turn off under zero-current switching conditions;
(g) reflecting a difference current between the magnetizing current and the output inductor current back to the primary side, said reflected difference current discharging parasitic capacitances across the primary switching elements and the clamp switching elements;
(h) turning on the first and second primary switching elements under zero-voltage switching conditions; and
(i) repeating steps (a) through (h) in a repetitive switching cycle.

3. ADC-DC converter comprising:
(a) a primary side and a secondary side;
(b) an input voltage source coupled to the primary side;
(c) a transformer comprising at least two primary windings, including a first primary winding and a second primary winding, disposed on the primary side in series and each having first and second terminals and a third terminal, wherein the third terminal is a common connection between the first primary winding and the secondary primary winding, and at least one secondary winding disposed on the secondary side, said primary windings and the at least one secondary winding being magnetically coupled and defining a leakage inductance in between, wherein a magnetizing current flows in the transformer;
(d) first and second primary switching elements disposed on the primary side, each of the first and second primary switching elements being connected to a respective terminal of the input voltage source and to a respective terminal of the primary windings, said terminals not being connected together;
(e) two capacitors connected in series across the input voltage source, wherein the capacitors are connected to the common connection of the primary windings, via a resistor;
(f) the first and second primary windings are configured to inject a displacement current into the secondary winding having a same amplitude and an opposite polarity to each other;
(g) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(h) an output inductor associated with each said set of switching elements, the output inductor being coupled in series with a corresponding output capacitor, wherein the series connection of the output inductor and the output capacitor forms an output filter network coupled across the corresponding freewheeling switching element, and wherein an output load is coupled across the output capacitors of all said sets connected in parallel; and
(i) a first clamp circuit coupled across the first primary switching element and a second clamp circuit coupled across the second primary switching element, each clamp circuit comprising a clamp switching element connected in series with a clamp capacitor;
(j) wherein each clamp switching element is controlled complementary to the corresponding primary switching element such that the primary switching element conducts while the corresponding clamp switching element is non-conducting, and vice versa, with a predetermined dead time between conduction intervals.

4. The DC-DC converter of claim 3, operating according to a method comprising:
(a) turning on the first and second primary switching elements, for a predetermined on time, thereby applying the input voltage to the primary winding of the transformer and causing a magnetizing current to build up in the transformer and an output current to build up in the output inductor;
(b) turning on the forward secondary switching element during said predetermined on time, to transfer energy to the secondary side;
(c) after said predetermined on-time, turning off the first and second primary switching elements;
(d) after a first predetermined first dead time, turning on the clamp switching elements, thereby providing a current path for the magnetizing current;
(e) allowing the output current to flow through a body diode of the freewheeling secondary switching element and subsequently turning on the freewheeling secondary switching element after a second predetermined dead time;
(f) allowing the magnetizing current flowing in the secondary winding to exceed the current drawn by the output inductor, thereby forcing the current through the freewheeling secondary switching element to reach zero and turn off under zero-current switching conditions;
(g) reflecting a difference current between the magnetizing current and the output inductor current back to the primary side, said reflected difference current discharging parasitic capacitances across the primary switching elements and the clamp switching elements;
(h) turning on the first and second primary switching elements under zero-voltage switching conditions; and
(i) repeating steps (a) through (h) in a repetitive switching cycle.

5. ADC-DC converter comprising:
(a) a primary side and a secondary side;
(b) an input voltage source coupled to the primary side;
(c) a transformer comprising at least one primary winding disposed on the primary side and having first and second terminals, and at least one secondary winding disposed on the secondary side, said primary and secondary windings being magnetically coupled and defining a leakage inductance therebetween, wherein a magnetizing current flows in the transformer;
(d) first and second primary switching elements disposed on the primary side, each of the first and second primary switching elements being connected to a respective terminal of the input voltage source and to a respective terminal of the primary winding;
(e) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(f) an output inductor associated with each of the secondary switching elements, the output inductor being coupled in series with a corresponding output capacitor, wherein a series connection of the output inductor and the output capacitor forms an output filter network coupled across the corresponding freewheeling switching element, and wherein an output load is coupled across the output capacitors of all of the sets connected in parallel;
(g) a first clamp circuit coupled across the first primary switching element and a second clamp circuit coupled across the second primary switching element, wherein each clamp circuit comprises a clamp switching element connected in series with a clamp capacitor;
(h) wherein each clamp switching element is controlled complementary to the corresponding primary switching element such that the primary switching element conducts while the corresponding clamp switching element is non-conducting, and vice versa, with a predetermined dead time between conduction intervals;
(i) a current injection winding in the transformer coupled with the primary and the secondary in said transformer, a current injection switch connected in series with an auxiliary winding and further in series to a current injection capacitor, wherein a current injection diode is connected to the termination of the current injection capacitor, which is connected to the said current injection winding; and
(j) a clamp diode in series with a clamp capacitor is connected across the forward switching element so that the clamp capacitor is connected to the source of the forward switching element;
(k) wherein the clamp capacitor with the termination is not connected to the source of the forward switching element which is connected to the current injection diode.

6. The DC-DC converter of claim 5, operating according to a method comprising:
(a) turning on a current injection switching element prior to turning on the first and second primary switching elements by a first predetermined time interval, such that a current injection current having a substantially half-sinusoidal waveform flows through the current injection switching element, the current injection capacitor, and the current injection inductive element;
(b) reflecting the current injection current into a secondary winding, wherein the reflected current injection current adds to a magnetizing current flowing in the secondary winding, and wherein a sum of the magnetizing current and the reflected current injection current exceeds a current flowing through an output inductor, thereby forcing a current through a freewheeling secondary switching element to reach zero and causing said freewheeling secondary switching element to turn off under zero-current switching conditions;
(c) reflecting a difference current equal to the magnetizing current plus the reflected current injection current minus the output inductor current back to a primary side, wherein the reflected difference current discharges parasitic capacitances across the first and second primary switching elements and across corresponding clamp switching elements;
(d) turning on the first and second primary switching elements under zero-voltage switching conditions;
(e) after a second predetermined time interval, turning off the current injection switching element;
(f) during a time interval in which the current injection switching element is conducting, partially discharging a clamp capacitor coupled to a forward secondary switching element by a current flowing through a current injection diode, thereby substantially eliminating voltage spikes across the forward secondary switching element when the first and second primary switching elements turn off, and
(g) repeating steps (a) through (f) during successive switching cycles.

7. ADC-DC converter comprising:
(a) a primary side and a secondary side;
(b) an input voltage source coupled to the primary side;
(c) a transformer comprising at least two primary windings, including a first primary winding and a second primary winding, disposed on the primary side in series and each having first and second terminals and a third terminal, wherein the third terminal is a common connection between the first primary winding and the secondary primary winding, and at least one secondary winding disposed on the secondary side, wherein the primary and secondary windings are magnetically coupled and define a leakage inductance in between, wherein a magnetizing current flows in the transformer;
(d) first and second primary switching elements disposed on the primary side, each of the first and second primary switching elements being connected to a respective terminal of the input voltage source and to a respective terminal of the primary windings, the terminals of the primary windings not being connected together;
(e) two capacitors connected in series across the input voltage source, wherein the capacitors are connected to the common connection of the primary windings, via a resistor;
(f) the first primary and second primary windings inject a displacement current into the secondary winding having a same amplitude and an opposite polarity to each other;
(g) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(h) an output inductor associated with each said set of secondary switching elements, the output inductor being coupled in series with a corresponding output capacitor, wherein the series connection of the output inductor and the output capacitor forms an output filter network coupled across the corresponding freewheeling switching element, and wherein an output load is coupled across the output capacitors of all said sets connected in parallel;
(i) a first clamp circuit coupled across the first primary switching element and a second clamp circuit coupled across the second primary switching element, each clamp circuit comprising a clamp switching element connected in series with a clamp capacitor;
(j) wherein each clamp switching element is controlled complementary to the corresponding primary switching element such that the primary switching element conducts while the corresponding clamp switching element is non-conducting, and vice versa, with a predetermined dead time between conduction intervals;
(k) a current injection winding in the transformer coupled with the primary and the secondary in said transformer, a current injection switch connected in series an auxiliary winding, and further in series to a current injection capacitor, wherein a current injection diode is connected to the termination of the current injection capacitor, which is connected to the said current injection winding;
(l) a clamp diode in series with a clamp capacitor is connected across the forward switching element so that the clamp capacitor is connected to the source of the forward switching element; and
(m) the clamp capacitor with the termination which is not connected to the source of forward switching element is connected to the current injection diode.

8. The DC-DC converter of claim 7, operating according to a method comprising:
(a) turning on a current injection switching element prior to turning on the first and second primary switching elements by a first predetermined time interval, such that a current injection current having a substantially half-sinusoidal waveform flows through the current injection switching element, the current injection capacitor, and the current injection inductive element;
(b) reflecting the current injection current into a secondary winding, wherein the reflected current injection current adds to a magnetizing current flowing in the secondary winding, and wherein a sum of the magnetizing current and the reflected current injection current exceeds a current flowing through an output inductor, thereby forcing a current through a freewheeling secondary switching element to reach zero and causing said freewheeling secondary switching element to turn off under zero-current switching conditions;
(c) reflecting a difference current equal to the magnetizing current plus the reflected current injection current minus the output inductor current back to a primary side, wherein the reflected difference current discharges parasitic capacitances across the first and second primary switching elements and across corresponding clamp switching elements;
(d) turning on the first and second primary switching elements under zero-voltage switching conditions;
(e) after a second predetermined time interval, turning off the current injection switching element;
(f) during a time interval in which the current injection switching element is conducting, partially discharging a clamp capacitor coupled to a forward secondary switching element by a current flowing through a current injection diode, thereby substantially eliminating voltage spikes across the forward secondary switching element when the first and second primary switching elements turn off, and
(g) repeating steps (a) through (f) during successive switching cycles.

9. ADC-DC converter comprising:
(a) a primary side and a secondary side;
(b) an input voltage source coupled to the primary side;
(c) a transformer comprising at least one primary winding disposed on the primary side and having first and second terminals, and at least one secondary winding disposed on the secondary side, said primary winding and said secondary winding being magnetically coupled and defining a leakage inductance therebetween, wherein a magnetizing current flows in the transformer;
(d) first and second primary switching elements disposed on the primary side, each of the first and second primary switching elements being connected to a respective terminal of the input voltage source and to a respective terminal of the primary winding;
(e) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(f) an output inductor associated with each of the secondary switching elements, the output inductor being coupled in series with a corresponding output capacitor, wherein a series connection of the output inductor and the output capacitor forms an output filter network coupled across the corresponding freewheeling switching element, and wherein an output load is coupled across the output capacitors of all said sets connected in parallel;
(g) a first clamp circuit coupled across the first primary switching element and a second clamp circuit coupled across the second primary switching element, each clamp circuit comprising a clamp switching element connected in series with a clamp capacitor;
(h) wherein each clamp switching element is controlled complementary to the corresponding primary switching element such that the primary switching element conducts while the corresponding clamp switching element is non-conducting, and vice versa, with a predetermined dead time between conduction intervals;
(i) a current injection switch placed in series with a current injection inductor and further to a current injection capacitor forming a current injection network connected across the secondary winding, wherein a current injection diode is connected to an end of current injection capacitor not connected to the secondary winding;
(j) a clamp diode in series with a clamp capacitor is connected across said forward switching element so that said clamp capacitor is connected to the source of said forward switching element; and
(k) the clamp capacitor with the termination which is not connected to the source of the forward switching element is connected to the current injection diode.

10. The DC-DC converter of claim 9, operating according to a method comprising:
(a) turning on a current injection switching element prior to turning on first and second primary switching elements by a first predetermined time interval, such that a current injection current having a substantially half-sinusoidal waveform flows through the current injection switching element, the current injection capacitor, and the current injection inductive element;
(b) reflecting the current injection current into a secondary winding, wherein the reflected current injection current adds to a magnetizing current flowing in the secondary winding, and wherein a sum of the magnetizing current and the reflected current injection current exceeds a current flowing through the output inductor, thereby forcing a current through a freewheeling secondary switching element to reach zero and causing said freewheeling secondary switching element to turn off under zero-current switching conditions;
(c) reflecting a difference current equal to the magnetizing current plus the reflected current injection current minus the output inductor current back to a primary side, said reflected difference current discharging parasitic capacitances across the first and second primary switching elements and across corresponding clamp switching elements;
(d) turning on the first and second primary switching elements under zero-voltage switching conditions;
(e) after a second predetermined time interval, turning off the current injection switching element;
(f) during a time interval in which the current injection switching element is conducting, partially discharging a clamp capacitor coupled to a forward secondary switching element by a current flowing through a current-injection diode, thereby substantially eliminating voltage spikes across the forward secondary switching element when the first and second primary switching elements turn off, and
(g) repeating steps (a) through (f) during successive switching cycles.

11. A DC-DC converter comprising:
(a) a primary side and a secondary side;
(b) an input voltage source coupled to the primary side;
(c) a transformer comprising at least two primary windings, including a first primary winding and a second primary winding, disposed on the primary side in series and each having first and second terminals and a third terminal, the third terminal defining a common connection between the first primary winding and the secondary primary winding, and at least one secondary winding disposed on the secondary side, the primary and secondary windings being magnetically coupled and defining a leakage inductance in between, wherein a magnetizing current flows in the transformer;
(d) first and second primary switching elements disposed on the primary side, each of the first and second primary switching elements being connected to a respective terminal of the input voltage source and to a respective terminal of the primary windings, said primary windings terminals which are not connected together;
(e) two capacitors connected in series across the input voltage source, wherein the capacitors are connected to the common connection of the primary windings, via a resistor;
(f) the first primary and second primary windings inject a displacement current into the secondary winding having a same amplitude and an opposite polarity to each other;
(g) at least one set of secondary switching elements, each set comprising a first secondary switching element and a second secondary switching element disposed on the secondary side and coupled to a respective secondary winding, wherein the first secondary switching element is configured as a forward switching element and the second secondary switching element is configured as a freewheeling switching element;
(h) an output inductor associated with each said set, the output inductor being coupled in series with a corresponding output capacitor, wherein the series connection of the output inductor and the output capacitor forms an output filter network coupled across the corresponding freewheeling switching element, and wherein an output load is coupled across the output capacitors of all the sets connected in parallel;
(i) a first clamp circuit coupled across the first primary switching element and a second clamp circuit coupled across the second primary switching element, each clamp circuit comprising a clamp switching element connected in series with a clamp capacitor;
(j) wherein each clamp switching element is controlled complementary to the corresponding primary switching element such that the primary switching element conducts while the corresponding clamp switching element is non-conducting, and vice versa, with a predetermined dead time between conduction intervals;
(k) a current injection switch placed in series with a current injection inductor and further to a current injection capacitor forming a current injection network connected across the secondary winding, wherein a current injection diode is connected to an end of current injection capacitor not connected to the secondary winding;
(l) a clamp diode in series with a clamp capacitor is connected across said forward switching element in such way that said clamp capacitor is connected to the source of said forward switching element; and
(m)said clamp capacitor with the termination not connected to the source of forward switching element is connected to said current injection diode.

12. The DC-DC converter of claim 11, operating according to a method comprising:
(a) turning on a current injection switching element prior to turning on first and second primary switching elements by a first predetermined time interval, such that a current injection current having a substantially half-sinusoidal waveform flows through the current injection switching element, the current injection capacitor, and the current injection inductive element;
(b) reflecting said current injection current into a secondary winding, wherein the reflected current adds to a magnetizing current flowing in the secondary winding, and wherein a sum of the magnetizing current and the reflected current injection current exceeds a current flowing through an output inductor, thereby forcing a current through a freewheeling secondary switching element to reach zero and causing said freewheeling secondary switching element to turn off under zero-current switching conditions;
(c) reflecting a difference current equal to the magnetizing current plus the reflected current injection current minus the output inductor current back to a primary side, said reflected difference current discharging parasitic capacitances across the first and second primary switching elements and across corresponding clamp switching elements;
(d) turning on the first and second primary switching elements under zero-voltage switching conditions;
(e) after a second predetermined time interval, turning off the current injection switching element;
(f) during a time interval in which the current injection switching element is conducted, partially discharging a clamp capacitor coupled to a forward secondary switching element by a current flowing through a current injection diode, thereby substantially eliminating voltage spikes across the forward secondary switching element when the first and second primary switching elements turn off, and
(g) repeating steps (a) through (f) during successive switching cycles.
